(19) United States
(12) Patent Application Publication
(10) Pub. No.: US 2026/0175740 A1
(43) Pub. Date: Jun. 25, 2026

(54) CONTROL DEVICE FOR VEHICLE

(71) Applicant: TOYOTA JIDOSHA KABUSHIKI KAISHA, Toyota-shi (JP)

(72) Inventor: Shunya YOKOTE, Toyota-shi (JP)

(73) Assignee: TOYOTA JIDOSHA KABUSHIKI KAISHA, Toyota-shi (JP)

(21) Appl. No.: 19/383,762

(22) Filed: Nov. 10, 2025

(30) Foreign Application Priority Data
Dec. 24, 2024 (JP) 2024-227648

(51) Int. Cl. B60L 58/26; B60H 1/00; B60H 1/32

(52) U.S. Cl. CPC B60L 58/26; B60H 1/00278; B60H 1/3208; B60L 2240/545

(57) ABSTRACT

The control ECU controls the vehicle. The vehicle includes a battery and a compressor. The battery is cooled by cooling energy of the refrigerant. The control ECU is configured to control the compressor such that the compressor is maintained at the rotation speed at which charging electric power equal to or higher than a charging electric power limit value is not supplied to the battery. As a result, even when the rotation speed of the compressor decreases during the external charging, the compressor is controlled such that the compressor is maintained at the rotation speed at which the charging electric power equal to or higher than the charging electric power limit value is not supplied to the battery. Therefore, it is possible to suppress the supply of the charging electric power equal to or higher than the charging electric power limit value to the battery.

### CROSS-REFERENCE TO RELATED APPLICATION

This application claims priority to Japanese Patent Application No. 2024-227648 filed on December 24, 2024. The disclosure of the above-identified application, including the specification, drawings, and claims, is incorporated by reference herein in its entirety.

### BACKGROUND

### 1. Technical Field

The present disclosure relates to a control device for a vehicle. In particular, the present disclosure relates to a control device for a vehicle that includes a power storage device configured to store electric power for driving the vehicle, the power storage device being configured to receive external charging, and a compressor configured to compress a refrigerant for lowering a temperature of a vehicle cabin using rotational force from the electric power of the power storage device.

### 2. Description of Related Art

In the related art, there has been a control technique of operating a compressor of an air conditioner to cool a power storage device during external charging (see, for example, Japanese Patent No. 7092429 (JP 7092429 B) and Japanese Unexamined Patent Application Publication No. 2002-354608 (JP 2002-354608 A)).

### SUMMARY

There is a vehicle in which a compressor that is operating during external charging is stopped when an ignition switch is turned from ON to OFF. Accordingly, when the rotation speed of the compressor decreases sharply, the cooling capability of a power storage device deteriorates. Therefore, the temperature of the power storage device may increase. In addition, when a requested value of electric power to be supplied from charging equipment is set as a value obtained by adding the power consumption of the compressor for cooling the power storage device during charging to a charging electric power limit value Win of the power storage device, the following problems occur. When the rotation speed of the compressor decreases sharply, the power consumption of the compressor also decreases sharply. As a result, electric power exceeding the charging electric power limit value Win is supplied to the power storage device. Consequently, problems such as lithium deposition on an electrode of the power storage device occur. In order to avoid the problems, when the requested value of the electric power to be supplied from the charging equipment is set to the charging electric power limit value Win of the power storage device, charging electric power decreases due to the power consumption of the compressor. Therefore, the charging time increases.

The present disclosure has been made to solve the problems described above, and an object thereof is to provide a control device for a vehicle that can suppress a risk of overheating due to the power storage device not being cooled during external charging.

A control device according to the present disclosure controls a vehicle.

The vehicle includes a power storage device configured to store electric power for driving the vehicle, the power storage device being configured to receive external charging, and a compressor configured to compress a refrigerant for lowering a temperature of a vehicle cabin using rotational force from the electric power of the power storage device.

The power storage device is cooled by cooling energy of the refrigerant.

The control device is configured to control the compressor such that, when a decrease in a rotation speed of the compressor satisfies a predetermined condition during the external charging of the power storage device, the compressor is maintained at the rotation speed at which charging electric power equal to or higher than a charging electric power limit value is not supplied to the power storage device.

With such a configuration, even when the rotation speed of the compressor decreases during the external charging of the power storage device, the compressor is controlled such that the compressor is maintained at the rotation speed at which the charging electric power equal to or higher than the charging electric power limit value is not supplied to the power storage device. Therefore, it is possible to restrain the charging electric power equal to or higher than the charging electric power limit value from being supplied to the power storage device. As a result, it is possible to provide a control device for a vehicle that can suppress a risk of overheating due to the power storage device not being cooled during the external charging.

The control device may be configured to set, as requested electric power for the external charging, electric power obtained by adding power consumption of the compressor to the charging electric power limit value.

With such a configuration, the charging electric power equal to the charging electric power limit value is continuously supplied to the power storage device. As a result, it is possible to suppress the application of the charging electric power exceeding the charging electric power limit value to the power storage device. In addition, it is possible to suppress an increase in the charging time of the power storage device.

The control device may be configured to perform control such that, when the decrease in the rotation speed of the compressor satisfies the predetermined condition during the external charging of the power storage device, the rotation speed is maintained, and electric power from the external charging is consumed by a specific device that consumes the electric power instead of or together with the compressor.

With such a configuration, even when the rotation speed of the compressor decreases during the external charging of the power storage device, the electric power exceeding the charging electric power limit value for the power storage device can be consumed by the specific device. As a result, it is possible to suppress the supply of the charging electric power exceeding the charging electric power limit value.

The specific device may be an inverter of a motor for driving the vehicle.

With such a configuration, even when the rotation speed of the compressor decreases during the external charging of the power storage device, the electric power exceeding the charging electric power limit value for the power storage device can be consumed by the inverter. As a result, it is possible to suppress the supply of the charging electric power exceeding the charging electric power limit value.

According to this disclosure, it is possible to provide a control device for a vehicle that can suppress a risk of overheating due to the power storage device not being cooled during external charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle according to the embodiment;

FIG. 2 is a diagram illustrating an example of a cooling device; and

FIG. 3 is a flowchart showing a flow of the charging electric power control processing according to the embodiment.

### DETAILED DESCRIPTION OF EMBODIMENTS

Hereinafter, an embodiment of this disclosure will be described in detail with reference to the drawings. Note that, in the drawings, the same or equivalent parts are denoted by the same reference numerals, and description thereof will not be repeated.

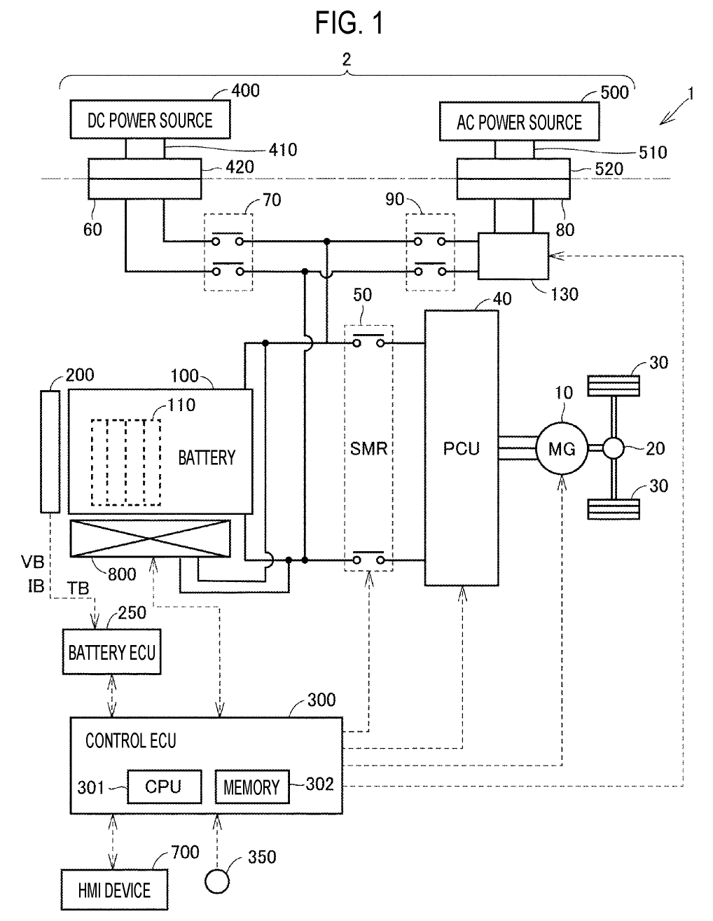

FIG. 1 is a schematic configuration diagram of a vehicle 1 according to the embodiment. In the embodiment, the vehicle 1 is an electrified vehicle, and is, for example, a battery electric vehicle (BEV). The vehicle 1 includes a motor generator (MG) 10, a power transmission gear 20, drive wheels 30, a power control unit (PCU) 40, a system main relay (SMR) 50, a battery 100, a monitoring unit 200, a battery electronic control unit (ECU) 250, and a control ECU 300.

The MG 10 has a function as an electric motor (motor) and a function as a generator. An output torque of the MG 10 is transmitted to the drive wheels 30 via the power transmission gear 20 configured by including a speed reducer, a differential gear, and the like.

When the vehicle 1 is braked, the MG 10 is driven by the drive wheels 30, and the MG 10 operates as the generator. The regenerative electric power generated by a regenerative braking force in the MG 10 is accumulated in the battery 100.

The PCU 40 is an electric power conversion device that converts the electric power bidirectionally between the MG 10 and the battery 100. The PCU 40 includes, for example, an inverter and a converter that operate based on a control signal from the control ECU 300, and drives the MG 10.

The SMR 50 is electrically connected to an electric power line that connects the battery 100 and the PCU 40. When the SMR 50 is turned ON in response to the control signal from the control ECU 300 and is in a conductive state, the electric power may be exchanged between the battery 100 and the PCU 40. On the other hand, when the SMR 50 is turned OFF and is in a cutoff state, the electrical connection between the battery 100 and the PCU 40 is cut off.

The battery 100 accumulates the electric power for driving the MG 10. The battery 100 is a secondary battery and is a battery pack including a plurality of battery cells 110. Each battery cell may be, for example, a lithium ion battery and may be a nickel-metal hydride battery or an all-solid-state battery.

The monitoring unit 200 includes a voltage detection unit, a current sensor, and a temperature detection unit. The voltage detection unit detects a voltage VB of the battery. The current sensor detects a current IB input and output to and from the battery 100. The temperature detection unit detects a temperature TB of the battery 100. The voltage VB, the temperature TB, and the current IB are input to the battery ECU 250. The battery ECU 250 calculates a state of charge (SOC) of the battery 100. The SOC may be calculated, for example, by a coulomb counting method, an SOC-OCV (open circuit voltage) characteristic, or a combination thereof. The voltage VB, the temperature TB, the current IB, and the SOC are output from the battery ECU 250 to the control ECU 300.

The vehicle 1 includes a DC inlet 60 and an AC inlet 80. Charging (external charging) of the battery 100 is possible from charging equipment (EVSE: Electric Vehicle Supply Equipment) 2 that includes an external DC power source 400, an external AC power source 500, or the like. When the connector 420 provided at the tip end of the charging cable 410 of the external DC power source (EVSE) 400 is connected to the DC inlet 60, the charging relay 70 is controlled to a connected state, and external charging (fast charging) of the battery 100 is executed.

When the connector 520 provided at the tip end of the charging cable 510 of the external AC power source (EVSE) 500 is connected to the AC inlet 80, the onboard charger 130 converts the alternating current power supplied from the external AC power source into direct current power. The direct current power output from the onboard charger 130 is supplied to the battery 100 via the charging relay 90, and the external charging (normal charging) of the battery 100 is executed.

The control ECU 300 includes a central processing unit (CPU) 301 and a memory 302. The control ECU 300 controls each device such that the vehicle 1 is brought into a desired state, based on a signal received from the battery ECU 250, signals (for example, an accelerator operation amount signal, a vehicle speed signal, and the like) from various sensors (not shown), and information such as a map and a program stored in the memory 302. The control ECU 300 controls the cooling device 800. The battery ECU 250 also includes a CPU and a memory, as in the control ECU 300.

The power switch (ignition switch) 350 is operated by the user. For example, when the user operates the power switch 350 while pressing a brake pedal (not illustrated), the control ECU 300 controls the SMR 50 to be turned ON (conductive state). When the SMR 50 is turned ON, the PCU 40 enables the MG 10 to be driven (the drive system starts), and the vehicle 1 becomes capable of travel. When the vehicle 1 is in a state capable of travel and the user operates the power switch 350, the SMR 50 is turned OFF (cutoff state), the PCU 40 and the like (drive system) stop, and the vehicle 1 is brought into a stopped state.

A human machine interface (HMI) device 700 includes an input device and a display device. The input device and the display device may be a touch panel display.

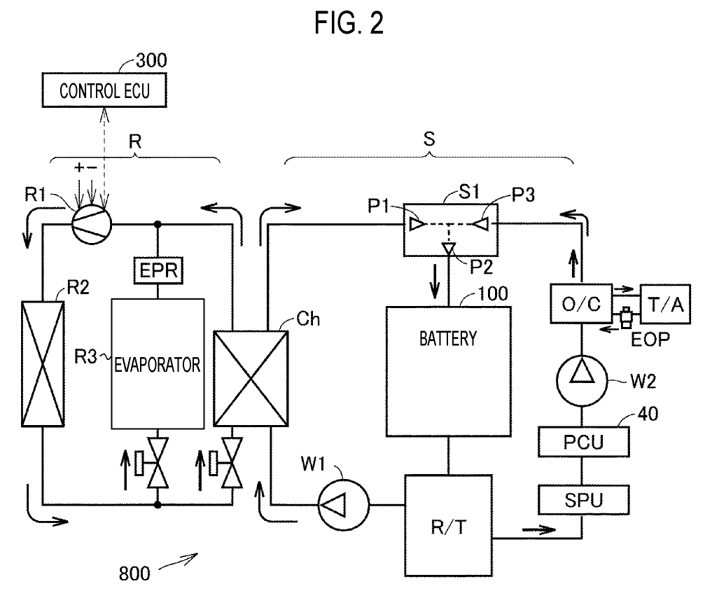

The vehicle 1 includes a cooling device 800. The cooling device 800 cools the battery 100. FIG. 2 is a diagram illustrating an example of the cooling device 800. In the present embodiment, the cooling device 800 is composed of a thermal management circuit capable of cooling and heating the battery 100. The cooling device 800 (thermal management circuit) includes a thermal circuit S and a refrigeration cycle R.

In the refrigeration cycle R, the refrigerant circulates. The refrigeration cycle R includes a compressor R1 and a condenser R2. The compressor R1 compresses the refrigerant by a motor capable of controlling the rotation speed, the motor operating with the electric power from the battery 100 in accordance with the control signal from the control ECU 300. The power consumption of the compressor R1 is substantially proportional to the flow rate of the refrigerant discharged from the compressor R1, that is, the rotation speed of the motor driving the compressor R1. The refrigerant compressed by the compressor R1 flows into the condenser R2. The high-pressure refrigerant discharged from the condenser R2 flows into the evaporator R3 via an electric expansion valve and flows into the chiller Ch via the electric expansion valve. The evaporator R3 is used as a cooling source for an air conditioning system of the vehicle 1. The chiller Ch performs heat exchange with a heat medium circulating in the thermal circuit S, thereby cooling the heat medium.

In the thermal circuit S, the heat medium circulates. The thermal circuit S includes a three-way valve S1, the battery 100, a reserve tank (R/T), a smart power unit (SPU), the PCU 40, an oil cooler (O/C), and pumps W1, W2. The oil cooler cools oil for cooling a transaxle (T/A) with the heat medium of the thermal circuit S. The EOP circulates oil for cooling a transaxle. When the pump W1 operates and the port P1 and the port P2 of the three-way valve S1 are connected, the heat medium cooled by the chiller Ch circulates in the battery 100, so that the battery 100 is cooled. When the pump W2 operates and the port P2 and the port P3 of the three-way valve S1 are connected, the heat medium heated by waste heat of the SPU, the PCU 40, and the O/C circulates in the battery 100, so that the battery 100 is heated. An electric heater may be provided between the port P2 and the battery 100.

The heat medium circulating in the thermal circuit S may be, for example, an insulating oil or an insulating antifreeze. The refrigeration cycle R and the thermal circuit S (the compressor R1, the pumps W1, W2, and the like) are driven by the electric power stored in the battery 100.

In the vehicle 1, when the power switch 350 is turned from ON to OFF, the control of the air conditioner is reset, thereby stopping the compressor R1 that has been operating during the external charging. Accordingly, when the rotation speed of the compressor R1 decreases sharply, the cooling capability of the battery 100 deteriorates. Therefore, the temperature of the battery 100 may increase. In addition, when a requested value of the electric power to be supplied from the charging equipment such as the external DC power source 400 or the external AC power source 500 is set as a value obtained by adding the power consumption of the compressor R1 for cooling the battery 100 during the charging to the charging electric power limit value Win of the battery 100, the following problems occur. When the rotation speed of the compressor R1 decreases sharply, the power consumption of the compressor R1 also decreases sharply. As a result, electric power exceeding the charging electric power limit value Win is supplied to the battery 100. Consequently, problems such as lithium deposition on an electrode of the battery cell 110 of the battery 100 occur. In order to avoid the problems, when the requested value of the electric power to be supplied from the charging equipment is set to the charging electric power limit value Win of the battery 100, the charging electric power decreases due to the power consumption of the compressor R1. Therefore, the charging time increases.

The control ECU 300 is configured to control the compressor R1 such that, when a decrease in a rotation speed of the compressor R1 satisfies a predetermined condition during the external charging of the battery 100, the compressor R1 is maintained at the rotation speed at which charging electric power equal to or higher than a charging electric power limit value Win is not supplied to the battery 100.

As a result, even when the rotation speed of the compressor R1 decreases during the external charging of the battery 100, the compressor R1 is controlled such that the compressor R1 is maintained at the rotation speed at which the charging electric power equal to or higher than the charging electric power limit value Win is not supplied to the battery 100. Therefore, it is possible to prevent the charging electric power equal to or higher than the charging electric power limit value Win from being supplied to the battery 100. As a result, it is possible to suppress the risk of overheating due to the battery 100 not being cooled during the external charging.

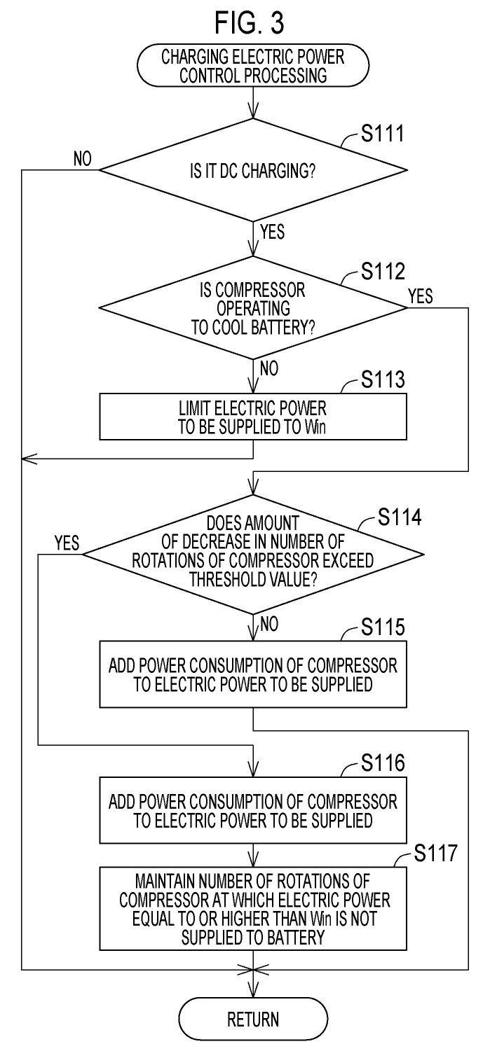

FIG. 3 is a flowchart showing a flow of the charging electric power control processing according to the embodiment. With reference to FIG. 3, the charging electric power control processing is called, from a higher-level processing, and executed by the control ECU 300 at a predetermined cycle.

The CPU 301 of the control ECU 300 determines whether the external charging from the external DC power source 400 to the battery 100 of the vehicle 1 is being performed (S111). When it is determined that the DC charging is being performed (YES in S111), the CPU 301 determines whether the compressor R1 is operating for cooling the battery 100 (S112). When it is determined that the DC charging is not being performed (NO in S111), the CPU 301 returns the processing to be executed to the higher-level processing, which is the calling source of the charging electric power control processing.

When it is determined that the compressor R1 is not operating (NO in S112), the CPU 301 limits the electric power to be supplied that is requested to be supplied from the external DC power source 400 to the charging electric power limit value Win of the battery 100 (S113). As a result, the charging electric power of the battery 100 is limited to the charging electric power limit value Win. After S113, the CPU 301 returns the processing to be executed to the higher-level processing, which is the calling source of the charging electric power control processing.

When it is determined that the compressor R1 is operating for cooling the battery (YES in S112), the CPU 301 determines whether the amount of decrease in the number of rotations (rotation speed) per unit time of the compressor R1 exceeds a predetermined threshold value (S114). The predetermined threshold value is a value determined such that the charging electric power of the battery 100 does not exceed the charging electric power limit value Win. When it is determined that the amount of decrease in the number of rotations does not exceed the predetermined threshold value (NO in S114), the CPU 301 adds the amount of power consumption of the compressor R1 to the electric power to be supplied that is requested to be supplied from the external DC power source 400 (S115). As a result, the electric power can be supplied from the external DC power source 400 to the compressor R1 while maintaining the charging electric power of the battery 100 at the charging electric power limit value Win. After S115, the CPU 301 returns the processing to be executed to the higher-level processing, which is the calling source of the charging electric power control processing.

On the other hand, when it is determined that the amount of decrease in the number of rotations exceeds the predetermined threshold value (YES in S114), the CPU 301 adds the amount of power consumption of the compressor R1 to the electric power to be supplied that is requested to be supplied from the external DC power source 400 (S116). Further, the CPU 301 controls the compressor R1 such that the compressor R1 is maintained at the number of rotations per unit time of the compressor R1 at which the electric power equal to or higher than the charging electric power limit value Win is not supplied to the battery 100 (S117). In other words, among the electric power to be supplied from the external DC power source 400, the electric power excluding the electric power equal to the charging electric power limit value Win supplied to the battery 100 is maintained at the number of rotations per unit time that can be consumed by the compressor R1. After S117, the CPU 301 returns the processing to be executed to the higher-level processing, which is the calling source of the charging electric power control processing.

### Modification

(1) In the embodiment described above, as illustrated in S117 of FIG. 3, among the electric power to be supplied from the external DC power source 400, the electric power excluding the electric power equal to the charging electric power limit value Win supplied to the battery 100 is consumed by the compressor R1. However, the present disclosure is not limited thereto. Among the electric power to be supplied from the external DC power source 400, the electric power excluding the electric power equal to the charging electric power limit value Win supplied to the battery 100 may be consumed by the compressor R1, as well as by the conduction loss of the inverter of the PCU 40 due to switching control and the copper loss of the MG 10. The inverter of the PCU 40 may consume the electric power instead of the compressor R1.

(2) In the embodiment described above, as illustrated in S111 of FIG. 3, when DC charging is being performed, the processing of S112 onward is executed. However, the present disclosure is not limited thereto. When AC charging is being performed, the processing of S112 onward may be executed.

(3) In the embodiment described above, as illustrated in FIG. 2, the heat medium of the thermal circuit S is cooled by the refrigerant of the refrigeration cycle R compressed by the compressor R1. Further, the battery 100 is cooled by the heat medium. However, the present disclosure is not limited thereto. As long as the battery 100 is cooled by the refrigerant compressed by the compressor R1, the battery 100 may be cooled by another method. For example, as illustrated in FIG. 2, the cooling may be performed by the refrigerant in a direct manner instead of cooling by the refrigerant in an indirect manner.

(4) In the embodiment described above, as illustrated in S114 of FIG. 3, the processing of S116 and S117 is executed when the amount of decrease in the number of rotations per unit time of the compressor R1 exceeds a predetermined threshold value. However, the present disclosure is not limited thereto. The processing of S116 and S117 need only be executed when the decrease in the rotation speed of the compressor R1 satisfies a predetermined condition during the external charging of the battery. The predetermined condition is not limited to a condition in which the amount of decrease in the number of rotations per unit time of the compressor R1 exceeds a predetermined threshold value. The predetermined condition may be a condition in which the rotation speed of the compressor R1 is less than a predetermined rotation speed determined such that the charging electric power of the battery 100 does not exceed the charging electric power limit value Win.

(5) In the embodiment described above, as illustrated in FIG. 3, the charging electric power of the battery 100 is limited to the charging electric power limit value Win, and the processing of FIG. 3 is executed using the charging electric power limit value Win. However, the present disclosure is not limited thereto. The processing of FIG. 3 may be executed using a value other than the charging electric power limit value Win. For example, the processing of FIG. 3 may be executed using a value that is a predetermined ratio (for example, 90%) of the charging electric power limit value Win. The processing of FIG. 3 may be executed using a value obtained by subtracting a predetermined value from the charging electric power limit value Win.

(6) The embodiment described above can be regarded as a disclosure of the vehicle 1, as illustrated in FIG. 1, or a control device such as the control ECU 300 of the vehicle 1. The present disclosure can be regarded as a disclosure of a control method or a control program, as illustrated in FIG. 3, executed by the vehicle 1 or by the control device of the vehicle 1.

### SUMMARY

(1) As illustrated in FIGS. 1 and 2, the control ECU 300 controls the vehicle 1. As illustrated in FIGS. 1 and 2, the vehicle 1 includes a battery 100 that is a power storage device configured to store electric power for driving the vehicle 1, the battery 100 being configured to receive external charging, and a compressor R1 configured to compress a refrigerant for lowering a temperature of a vehicle cabin by rotational force from the electric power of the battery 100. As illustrated in FIG. 2, the battery 100 is cooled by cooling energy of the refrigerant. As illustrated in FIG. 3, the control ECU 300 is configured to control the compressor R1 such that, when a decrease in a rotation speed of the compressor R1 satisfies a predetermined condition during the external charging of the battery 100, compressor R1 is maintained at the rotation speed at which charging electric power equal to or higher than a charging electric power limit value Win is not supplied to the battery 100 (for example, S114, S116, and S117).

As a result, even when the rotation speed of the compressor R1 decreases during the external charging of the battery 100, the compressor R1 is controlled such that the compressor R1 is maintained at the rotation speed at which the charging electric power equal to or higher than the charging electric power limit value Win is not supplied to the battery 100. Therefore, it is possible to prevent the charging electric power equal to or higher than the charging electric power limit value Win from being supplied to the battery 100. As a result, it is possible to suppress the risk of overheating due to the battery 100 not being cooled during the external charging.

(2) As illustrated in FIG. 3, the control ECU 300 may be configured to set, as the requested electric power for the external charging, electric power obtained by adding the power consumption of the compressor R1 to the charging electric power limit value Win (for example, S115 and S116).

As a result, the charging electric power equal to the charging electric power limit value Win is continuously supplied to the battery 100. As a result, it is possible to suppress the application of the charging electric power exceeding the charging electric power limit value Win to the battery 100. In addition, since the maximum charging electric power is continuously supplied to the battery 100, an increase in the charging time of the battery 100 can be suppressed.

(3) As illustrated in Modification, when the decrease in the rotation speed satisfies the predetermined condition during the external charging of the battery 100, the control ECU 300 performs control such that the rotation speed is maintained. Further, the electric power from the external charging may be controlled to be consumed by the specific device (for example, the inverter of the PCU 40 or the MG 10) that consumes the electric power instead of the compressor R1 or together with the compressor R1.

As a result, even when the rotation speed of the compressor R1 decreases during the external charging of the battery 100, electric power exceeding the charging electric power limit value Win for the battery 100 can be consumed by the specific device. As a result, it is possible to suppress the supply of the charging electric power exceeding the charging electric power limit value Win.

(4) As illustrated in Modification, the specific device may be the inverter of the PCU 40 of the MG 10 for driving the vehicle 1.

As a result, even when the rotation speed of the compressor R1 decreases during the external charging of the battery 100, electric power exceeding the charging electric power limit value Win for the battery 100 can be consumed by the inverter of the PCU 40. As a result, it is possible to suppress the supply of the charging electric power exceeding the charging electric power limit value Win.

The embodiment disclosed herein is to be considered merely illustrative and not restrictive in all respects. The scope of the present disclosure is indicated by the scope of claims rather than by the description of the above-described embodiment, and is intended to include all modifications within the scope and meaning equivalent to the scope of the claims.

What is claimed is:

1. A control device for a vehicle, wherein:
the vehicle includes
a power storage device configured to store electric power for driving the vehicle, the power storage device being configured to receive external charging, and
a compressor configured to compress a refrigerant for lowering a temperature of a vehicle cabin using rotational force from the electric power of the power storage device;
the power storage device is cooled by cooling energy of the refrigerant; and
the control device is configured to control the compressor such that, when a decrease in a rotation speed of the compressor satisfies a predetermined condition during the external charging of the power storage device, the compressor is maintained at the rotation speed at which charging electric power equal to or higher than a charging electric power limit value is not supplied to the power storage device.

2. The control device according to claim 1, wherein the control device is configured to set, as requested electric power for the external charging, electric power obtained by adding power consumption of the compressor to the charging electric power limit value.

3. The control device according to claim 1, wherein the control device is configured to perform control such that, when the decrease in the rotation speed of the compressor satisfies the predetermined condition during the external charging of the power storage device, the rotation speed is maintained, and electric power from the external charging is consumed by a specific device that consumes the electric power instead of or together with the compressor.

4. The control device according to claim 3, wherein the specific device is an inverter of a motor for driving the vehicle.
